(19) United States
(12) Patent Application Publication
(10) Pub. No.: US 2020/0227778 A1
(43) Pub. Date: Jul. 16, 2020

(54) HYBRID SOLID ELECTROLYTE FOR ALL-SOLID-STATE BATTERY

(71) Applicant: BLUE SOLUTIONS CANADA INC., Boucherville (CA)

(72) Inventors: Alain VALLEE, Boucherville (CA); Patrick LEBLANC, Boucherville (CA); Frederic COTTON, Montreal (CA); Brieuc GUILLERM, Montreal (CA)

(21) Appl. No.: 16/745,047

(22) Filed: Jan. 16, 2020

Related U.S. Application Data
(60) Provisional application No. 62/793,141, filed on Jan. 16, 2019.
(60) Provisional application No. 62/870,729, filed on Jul. 4, 2019.

(51) Int. Cl. H01M 10/0562; H01M 10/0525; H01M 10/0565; H01M 10/635; H01M 4/131; H01M 4/66; H01M 4/36

(52) U.S. Cl. CPC H01M 10/0562; H01M 10/0525; H01M 10/0565; H01M 2004/028; H01M 4/131; H01M 4/661; H01M 4/364; H01M 10/635

(57) ABSTRACT

The present technology generally relates to a hybrid solid electrolyte in the form of a composite material comprising a high content of polymer-in-salt in which particles of ionically conductive inorganic material are dispersed, to a method for its manufacturing and to a lithium-metal-polymer battery comprising said hybrid solid electrolyte.

### CROSS-REFERENCE TO RELATED APPLICATIONS

This application claims the benefit of and priority to U.S. provisional patent application No. 62/793,141, filed on Jan. 16, 2019; and to U.S. provisional patent application No. 62/870,729, filed on Jul. 4, 2019; the content of all of which is herein incorporated in entirety by reference.

### FIELD OF TECHNOLOGY

The present technology generally relates to the field of all-solid-state secondary batteries, in particular lithium-metal-polymer (LMP) batteries.

### BACKGROUND INFORMATION

LMP batteries generally take the form of an assembly of superposed thin films (roll or winding of n-turns of the following sequence {electrolyte/cathode/collector/cathode/electrolyte/anode}) or of n stacked thin films (that are cut and superposed, i.e. n stacks of the aforementioned sequence). This rolled/stacked unitary sequence has a thickness of about 100 μm. It is made up of four functional layers: i) a negative electrode (anode) that delivers lithium ions during the discharge of the battery; ii) a solid polymer electrolyte that is able to conduct lithium ions; iii) a positive electrode (cathode) that is composed of an active electrode material that acts as a receptacle into which the lithium ions intercalate; and lastly iv) a current collector that makes contact with the positive electrode and that makes electrical connection possible.

The negative electrode of LMP batteries generally comprises a sheet of lithium metal or of a lithium alloy; the solid polymer electrolyte is generally composed of a least one polymer based on poly(ethylene oxide) (PEO) and at least one lithium salt; the positive electrode is conventionally a material the working potential of which is lower than 4 V vs Li⁺/Li (i.e. the insertion/disinsertion potential of the lithium is lower than 4 V) such as for example a metal oxide (for example V₂O₅, LiV₃O₈, LiCoO₂, LiNiO₂, LiMn₂O₄ and LiNi_{0.5}Mn_{0.5}O₂, etc.) or a phosphate of LiMPO₄ type, where M is a metal cation selected from the group Fe, Mn, Co, Ni and Ti, or combinations of these cations (LiFePO₄ for example) and also contains carbon, at least one ionically conductive polymer and at least one lithium salt; and the current collector generally comprises of a sheet of metal.

The conductivity of the ions is ensured by the dissolving of the lithium salt in the poly(ethylene oxide). High molecular weight PEO doped with lithium salt has very good mechanical properties at ambient temperature, but is also a semi-crystalline polymer. The crystalline structure restricts the mobility of the chains and reduces the ionic conductivity of the polymer. Above the melting temperature of PEO (Tₘ˜60-65° C.), the ionic conductivity increases considerably to reach conductivity levels sufficient for battery operation (about 1.10⁻⁵ to 1.10⁻³ S/cm), but at these temperatures, PEO becomes a viscous liquid and loses its dimensional stability.

Thus, although PEO is a very good ion conductor, and easy to formulate, it does not have sufficient mechanical strength at the temperatures customarily used in a LMP battery (60-80° C.).

Other polymers based on poly(ethylene oxide) (PEO) have been described, such as statistical copolymers of poly(ethylene oxide-stat-propylene oxide) (e.g., PEO-stat-PPO) type, block copolymers of polystyrene-b-PEO (e.g., PS-b-PEO) type, crosslinked PEOs or copolymers comprising acrylate or methacrylate chains on which PEO is branched. Furthermore, it is known to add, to the PEO-based polymer, inorganic or organic particles, optionally nanoparticles, such as aluminium oxide or titanium oxide particles or cellulose nanofibrils.

However, these optionally composite polymer materials replacing the PEO in the solid polymer electrolyte mainly aim to strengthen the mechanical properties of the solid polymer electrolyte and/or to break the crystallinity of the PEO in order to obtain a better low-temperature conductivity and/or a barrier to dendritic growth and do not make it possible to improve the energy density of the battery.

EP 3 258 532, incorporated herein by reference, discloses an all-solid-state polymer electrolyte for a solid-state lithium battery comprising a carbonic ester polymer (e.g. polypropylene carbonate, preferably in an amount of 60% to 80%), a lithium salt (e.g. bistrifluoromethanesulfonimide lithium salt (LiTFSI) in an amount of 9% to 30%), an additive (e.g. silicon dioxide, in an amount of 0.5% to 30%), a solvent (e.g. N,N-dimethylformamide) and a porous support material (e.g. cellulose non-woven film). However, it has been shown in literature that transference number of lithium as well as conductivity can be further improved by increasing the salt concentration in such systems.

Electrolytes with high salts (above 50 wt. %) have also been proposed in order to obtain electrolytes of relatively high anion immobilization. Such electrolytes called Polymer-In-Salt-Electrolytes (PISE) or “rubbery electrolytes” were first described by C. A. Angell et al. (Nature, 1993, 363, 137-139), incorporated herein by reference, and then many works were presented concerning mainly polyacrylonitrile (PAN) based systems. Even if these PISE have some advantages such as a good conductivity at ambient temperature (e. g. up to 1.10⁻² Ω⁻¹/·cm′ at 25° C.), they are very expensive because of their very high content in salts, in particular in lithium salts.

In view of this, there would be advantageous to overcome the drawbacks of the aforementioned prior art and to provide a solid electrolyte having both a good mechanical strength and an optimized composition to be advantageously used at room temperature in an all-solid-state secondary battery, in particular in an LMP battery, while also being less expensive to manufacture than the solid electrolytes on the market.

### SUMMARY OF TECHNOLOGY

According to various aspects, the present technology relates to a hybrid solid polymer electrolyte comprising: at least one lithium salt in a molar percentage M1; and at least one ionically conductive polymer in a molar percentage M2; the at least one lithium salt and the at least one ionically conductive polymer forming a polymer-in-salt-electrolyte; wherein the molar percentage M1 is at least about 50 mol. % with regards to a total molar percentage M1+M2, and wherein the polymer-in-salt-electrolyte comprises particles of an ionically conductive inorganic material.

In some implementations of these aspects, the at least one lithium salt is selected from: lithium fluorate (LiFO₃), lithium bis(trifluoromethanesulfonyl)imide (LiTFSI), lithium hexafluorophosphate (LiPF₆), lithium fluoroborate (LiBF₄), lithium metaborate (LiBO₂), lithium perchlorate (LiClO₄), lithium nitrate (LiNO₃), lithium bis(fluorosulfonyl)imide (LiFSI), lithium iodide (LiI), lithium tetrachloroaluminate (LiAlCl₄), lithium difluoro(oxalate)borate (LiBF₂C₂O₄), and lithium acetate (LiOAc) and mixtures thereof.

In some further implementations of these aspects, the hybrid solid polymer electrolyte according to claim 1, wherein the at least one lithium salt is selected from: lithium fluorate (LiFO₃), lithium bis(trifluoromethanesulfonyl)imide (LiTFSI), lithium hexafluorophosphate (LiPF₆), lithium fluoroborate (LiBF₄), lithium metaborate (LiBO₂), lithium perchlorate (LiClO₄), lithium nitrate (LiNO₃), lithium bis(fluorosulfonyl)imide (LiFSI), and mixtures thereof.

In some further implementations of these aspects, the at least one lithium salt is lithium bis(trifluoromethanesulfonyl)imide (LiTFSI), or lithium bis(fluorosulfonyl)imide (LiFSI).

In some further implementations of these aspects, the at least one ionically conductive polymer is selected from: polyacrylonitriles (PANs), polyethylene carbonates (PECs), polyacrylamides (PAMs), polyethylene glycols (PEGs), polyethylene oxides (PEOs), polyhydroxyethylmethacrylates (P(HEMAs)), polyphosphonates (PPhs), polysiloxanes, polyamides (PAs), polydilactones, polydiesters, polyphasphazenes (PPHOSs), and polyurethane (PUs) and mixtures thereof.

In some further implementations of these aspects, the at least one ionically conductive polymer is selected from: polyacrylonitriles (PANs), polyethylene carbonates (PECs), and mixtures thereof.

In some further implementations of these aspects, the lithium conductive inorganic material is selected from: TiO₂, Li₂O, Al₂O₃, SiO₂, P₂O₅, GeO₂, a lithium perovskite material, Li₃N, Li-β-alumina, Lithium Super-ionic Conductors (LISICON), Lithium Aluminium Titanium Phosphate materials (LATP), Li_{2.88}PO_{3.86}N_{0.14} (LiPON), Li₉AlSiO₂, Li₁₀GeP₂S₁₂, lithium garnet materials, doped lithium garnet materials, and lithium garnet composite materials.

In some further implementations of these aspects, the lithium conductive inorganic material is selected from: TiO₂, Li₂O, Al₂O₃, SiO₂, P₂O₅, GeO₂, a lithium perovskite material, Li₃N, Li-β-alumina, Lithium Super-ionic Conductors (LISICON), Li_{2.88}PO_{3.86}N_{0.14} (LiPON), Li₉AlSiO₂, Li₁₀GeP₂S₁₂, lithium garnet materials, doped lithium garnet materials, and lithium garnet composite materials.

In some further implementations of these aspects, the lithium conductive inorganic material is Lithium Aluminium Titanium Phosphate materials (LATP) or lithium garnet materials.

According to some aspects, the present technology relates to a method for manufacturing a hybrid solid polymer electrolyte as defined herein. The method comprising: combining a molar amount M2 of at least one ionically conductive polymer with a molar amount M1 of at least one lithium salt to form a polymer-in-salt electrolyte in which M1 of the at least one lithium salt is above 50 mol. % with regards to a total molar percentage M1+M2; adding particles of an ionically conductive inorganic material to the at least one lithium salt and/or in said polymer-in-salt electrolyte to obtain a polymer-in-salt electrolyte comprising particles of an ionically conductive inorganic material; and applying the polymer-in-salt electrolyte comprising particles of an ionically conductive inorganic material on an inert substrate or directly on a positive or negative electrode.

According to one aspect, the present technology relates to a hybrid solid electrolyte in the form of a composite material comprising a high content of polymer-in-salt in which particles of ionically conductive inorganic material are dispersed, to a method for its manufacturing and to a lithium-metal-polymer battery comprising said hybrid solid electrolyte. The present technology applies in particular to the field of electric and hybrid vehicles, in which there is an increasing demand for autonomous and high energy density systems which guarantee a low environmental impact.

According to another aspect, the present technology relates to a hybrid solid polymer electrolyte comprising: at least one lithium salt in a molar percentage M1, and at least one ionically conductive polymer in a molar percentage M2, said at least one lithium salt and said at least one ionically conductive polymer form a polymer-in-salt-electrolyte, wherein the molar percentage M1 of said at least one lithium salt in said polymer-in-salt-electrolyte is above 50 mol. % with regards to the total molar percentage M1+M2, said polymer-in-salt-electrolyte further comprises particles of an ionically conductive inorganic material.

According to another aspect, the present technology relates to a method for the manufacturing of a hybrid solid polymer electrolyte. The method comprises the steps of: providing a solution of at least one lithium salt in an appropriate solvent, adding a molar amount M2 of at least one ionically conductive polymer in said solution of at least one lithium salt to form a polymer-in-salt electrolyte in which the molar percentage M1 of said at least one lithium salt in said polymer-in-salt-electrolyte is above 50 mol. % with regards to the total molar percentage M1+M2, adding particles of an ionically conductive inorganic material in said solution of at least one lithium salt and/or in said polymer-in-salt electrolyte to obtain a polymer-in-salt electrolyte comprising particles of an ionically conductive inorganic material, applying said polymer-in-salt electrolyte comprising particles of an ionically conductive inorganic material on an inert substrate or directly on a positive or negative electrode, drying said polymer-in-salt electrolyte comprising particles of an ionically conductive inorganic material to evaporate the solvent to obtain said hybrid solid polymer electrolyte.

According to another aspect, the present technology relates to an all-solid-state secondary battery, in particular a lithium-metal-polymer battery, comprising at least one positive electrode, said positive electrode being optionally support by a current collector, and at least one negative electrode, said electrodes being separated from each other by a solid-state electrolyte, wherein said solid-state electrolyte is a hybrid solid polymer electrolyte according to the first subject of the present invention.

Other aspects and features of the present disclosure will become apparent to those ordinarily skilled in the art upon review of the following description of specific embodiments.

### DETAILED DESCRIPTION OF TECHNOLOGY

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which variations and additions do not depart from the present technology. Hence, the following description is intended to illustrate some particular embodiments of the technology, and not to exhaustively specify all permutations, combinations and variations thereof.

As used herein, the singular form “a”, “an” and “the” include plural referents unless the context clearly dictates otherwise.

The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

As used herein, the term “mol.” refers to “molar”.

As used herein, the term “comprise” is used in its non-limiting sense to mean that items following the word are included, but items not specifically mentioned are not excluded.

i) Lithium Salt

In one embodiment, the lithium salt of the hybrid solid polymer electrolyte may be chosen from lithium fluorate (LiFO₃), lithium bis(trifluoromethanesulfonyl)imide (LiTFSI), lithium hexafluorophosphate (LiPF₆), lithium fluoroborate (LiBF₄), lithium metaborate (LiBO₂), lithium perchlorate (LiClO₄), lithium nitrate (LiNO₃), lithium bis(fluorosulfonyl)imide (LiFSI), lithium iodide (LiI), lithium tetrachloroaluminate (LiAlCl₄), lithium difluoro(oxalate)borate (LiBF₂C₂O₄), lithium acetate (LiOAc) and mixtures thereof. In some implementations of these embodiments, the lithium salt is LiFSI. In some other implementations of these embodiments, the lithium salt is LiTFSI.

In some other implementations of these embodiments, glyme is combined with the lithium salt (e.g., Li(G4)TFSI, G4 being a tetraglyme). In some instances, the lithium salt is combined with at least one ionic liquid. The ionic liquid can be nitrogen based (ammonium, imidazolium piperidinium, pyrrolidinium (PYR14TFSI or PYR12FSI for instance)) or phosphonium based (tributylmethylphosphonium, trihexyl(tetradecyl)phosphonium. The ionic liquid molecules can be part of polymer chains called poly(ionic liquids) and lithium salts can also be used in conjunction with poly(ionic liquids) (e.g., poly(diallyldimethylammonium TFSI)) to form a lithium salt.

In some embodiments, the molar amount (M1) of the lithium salt is present in the hybrid solid electrolyte in an amount that is at least about 50 mol. %, or is at least about 60 mol. %. In some embodiments, the lithium salt is present in the hybrid solid electrolyte in an amount that is between about 50 mol. % and about 95 mol. %, or is between about 60 mol. % and about 95 mol. %. The lithium salt is present in the hybrid solid electrolyte in an amount that is between about 50 mol. % and about 90 mol. %, or is between about 60 mol. % and about 90 mol. % with regards to the total molar amount M1+M2.

ii) Ionically Conductive Polymer

In one embodiment, the ionically conductive polymer of the hybrid solid polymer electrolyte are polymers that, when mixed with a metal salt, in particular with a lithium salt, have an initial conductivity of at least about 5·10⁻⁶ S/cm. In some implementations of these embodiments, the ionically conductive polymer is chosen from polyacrylonitriles (PANs), polyethylene carbonates (PECs), polyacrylamides (PAMs), polyethylene glycols (PEGs), polyethylene oxides (PEOs), polyhydroxyethylmethacrylates (P(HEMAs)), polyphosphonates (PPhs), polysiloxanes, polyamides (PAs), polydilactones, polydiesters, polyphasphazenes (PPHOSs), polyurethane (PUs) and mixtures thereof.

In some embodiments, the ionically conductive polymer of the hybrid solid polymer electrolyte has a molecular weight ranging from between about 3,000 and about 1,000,000 g/mole. In some embodiments, the ionically conductive polymer of the hybrid solid polymer electrolyte has a molecular weight ranging from between about 10,000 and about 200,000 g/mole.

In some embodiments, the molar amount M2 of the ionically conductive polymer in the hybrid solid electrolyte is less than about 40 mol. %. In some embodiments, the molar amount M2 of the ionically conductive polymer in the hybrid solid electrolyte is between about 5 mol. % and about 40 mol. %. In some embodiments, the molar amount M2 of the ionically conductive polymer in the hybrid solid electrolyte between about 10 mol. % and about 40 mol. %.

iii) Ionically Conductive Inorganic Material

In some embodiments, the ionically conductive inorganic material of the hybrid solid polymer electrolyte may be chosen from lithium conductive inorganic materials. Examples of ionically conductive inorganic material include, but are not limited to: TiO₂, Li₂O, Al₂O₃, SiO₂, P₂O₅, GeO₂, lithium perovskite materials such as for example lanthanum lithium titanate (La_{0.57}Li_{0.29}TiO₃: LLTO), Li₃N, Li-β-alumina, Lithium Super-ionic Conductors (LISICON), Lithium Aluminium Titanium Phosphate materials (LATP) such as for example Li_{1.5}Al_{0.5}Ti₁₅P₃O₁₂ or Li₁₃Al_{0.3}Ti_{1.2}P₃O₁₂, Li_{2.88}PO_{3.86}N_{0.14} (LiPON), Li₉AlSiO₂, Li₁₀GeP₂S₁₂, lithium garnet materials, doped lithium garnet materials, lithium garnet composite materials, and the like.

In various examples, the lithium garnet material is cation-doped L₁₅La₃X¹₂O₁₂, where X¹ is Nb, Zr, Ta, or combinations thereof, cation-doped Li₆La₂BaTa₂O₁₂, cation-doped Li₇La₃Zr₂O₁₂, and cation-doped Li₆BaY₂X¹₂O₁₂, where cation dopants are barium, yttrium, zinc, or combinations thereof, and the like. In various other examples, the lithium garnet material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂X¹₂O₁₂, Li₇Y₃Zr₂O₁₂, Li_{6.75}BaLa₂Nb_{1.75}Zr_{0.25}O₁₂, Li_{6.75}BaLa₂Ta_{1.75}Zr_{0.25}O₁₂, or the like.

In some instances, the ionically conductive inorganic material is in the form of particles with a particle size distribution D99<2 micrometers; or <1 micrometer and a particle size distribution D50<0.1 micrometer. As used herein, the D-values D99 and D50 given for the particle size distribution correspond to the intercepts for 99%, respectively 50%, of the cumulative mass of said particles.

In some instances, the ionically conductive inorganic material represents from about 30% to about 80%; or represented from about 40% to about 70% of the total volume of the hybrid solid polymer electrolyte.

In some instances, the polymer-in-salt electrolyte comprising the mixture of the lithium salt and the ionically conductive polymer represents from between about 20% and about 70%, or represents from between 30% and about 60% of the total volume of the hybrid solid polymer electrolyte.

iii) Additional Solvating Polymer

In some embodiments, the hybrid solid polymer electrolyte further comprises, in addition to the ionically conductive polymer as defined herein, at least one additional polymer selected among solvating polymers, in particular polyethylene oxide. The amount of solvating polymer is of the order of a few wt. % with regards to the total weight of the hybrid solid polymer electrolyte, typically ranging from about 2 and about 10 wt. %.

iv) Additional Non-Ionically Conductive Polymer

In some embodiments, the hybrid solid polymer electrolyte further comprises, in addition to the ionically conductive polymer as defined herein, at least one additional non-ionically conductive polymer to impart mechanical properties to the electrolyte. Examples of additional non-ionically conductive polymer include, but are not limited to: polyacrylates, and fluorinated polymers such as polyvinylidene fluoride (PVdF). The amount of the additional non-ionically conductive polymer may range from between about 10% and about 30% in volume; or between about 5% and 15% in volume, with regards to the total volume of the hybrid solid polymer electrolyte.

The thickness of the hybrid solid polymer electrolyte ranges from about a few microns to about 40 μm. In other instances, the thickness of the hybrid polymer electrolyte ranges from about 5 μm to about 10 μm.

The hybrid solid polymer electrolyte may be in any appropriate form, for example in the form of a sheet or a film.

v) Method of Manufacturing

In some embodiments, the present technology relates to a method of manufacturing the hybrid solid polymer electrolyte as defined herein. In some implementations of these embodiments, the method comprises providing a solution of at least one lithium salt in an appropriate solvent, and adding a molar amount M2 of at least one ionically conductive polymer in the solution of at least one lithium salt to form a polymer-in-salt electrolyte in which the molar percentage M1 of said at least one lithium salt in the polymer-in-salt-electrolyte is at least about 50 mol % with regards to the total molar percentage M1+M2.

In some instances, the method further comprises adding particles of an ionically conductive inorganic material in the solution of at least one lithium salt and/or in the polymer-in-salt electrolyte to obtain a polymer-in-salt electrolyte comprising particles of an ionically conductive inorganic material.

In some instances, the method further comprises applying said polymer-in-salt electrolyte comprising particles of an ionically conductive inorganic material on an inert substrate or directly on a positive or negative electrode, and drying said polymer-in-salt electrolyte comprising particles of an ionically conductive inorganic material to evaporate the solvent and obtain the hybrid solid polymer electrolyte. Examples of solvents that may be used in the method of the present technology include, but are not limited to: aqueous solvents such as water or non-aqueous solvents such as linear or cyclic ethers, carbonates, sulfuric solvents such as sulfolanes, sulfones, dimethylsulfoxide, linear or cyclic esters such as lactones, nitriles, or the like.

Further examples of solvents include: dimethylether, polyethylene glycol dimethylethers, dioxolane, ethylenecarbonate (EC), propylenecarbonate (PC), dimethylcarbonate (DMC), diethylcarbonate (DEC), methyl-isopropyl carbonate (MiPC), ethylacetate (EA), ethylbutyrate (EB), and mixtures thereof.

In some implementations, the lithium salt that may be used in the methods of the present technology is in a dry form which in some instances may alleviate the need for a solvent and/or a drying step.

When at least one additional solvating polymer and/or non-ionically conductive polymer is present in the hybrid solid polymer electrolyte, the at least one additional polymer may be added in the solution of at least one lithium salt and/or in the polymer-in-salt electrolyte.

The step of applying the polymer-in-salt electrolyte comprising particles of an ionically conductive inorganic material on an inert substrate or directly on a positive or negative electrode may be carried out by any technique known to a person skilled in the art such as for example by coating, by extrusion or by pressing (cold or hot).

The drying step can be performed by any technique known to a person skilled in the art such as for example by heating.

According to a further embodiment, the method of manufacturing the hybrid solid polymer electrolyte may further comprise an additional step of forming, on at least one face of the hybrid solid polymer electrolyte, an additional layer of an additional ionically conductive polymer different from the ionically conductive polymer present in the hybrid solid polymer electrolyte (for example polyethyleneoxide). The additional layer may comprise at least one lithium salt. Such an additional layer is designed to face and to be in contact with the negative electrode after assembling of the battery and has the advantage of further stabilizing the solid electrolyte interphase (SEI). The additional layer may have a thickness of less than about 2 μm.

vi) All-Solid-State Battery

In some embodiments, the present technology relates to all-solid-state secondary batteries such as lithium-metal-polymer batteries comprising at least one positive electrode.

The positive electrode being optionally supported by a current collector, and at least one negative electrode. In some instances, the electrodes are separated from each other by a solid-state electrolyte such as defined herein.

In some embodiments, the negative electrode of the lithium-metal-polymer battery is a film or a sheet of lithium metal or of a lithium alloy and the positive electrode of the lithium-metal-polymer battery is a composite material comprising at least positive electrode active material, optionally at least one binding polymer and at least one agent generating an electronic conductivity.

In some embodiments, the positive electrode active material is a lithium intercalation material the potential of which is greater than 3.7 V vs Li⁺/Li, or greater than 3.8 V vs Li⁺/Li, or 30 greater than or equal to 4 V.

The positive electrode active material may be chosen from vanadium oxide VOₓ (2≤x≤2.5), LiV₃O₈, Li_{y}Ni₁₋ₓCoₓO₂, (0≤x≤1; 0≤y≤1), manganese spinelles Li_{y}Mn₁₋ₓMₓO₂ (M ═Cr, Al, V, Ni, 0≤x≤0.5; 0≤y≤2), Lithium-Nickel-Manganese-Cobalt-Oxides materials (abbreviated as NMC) such as LiNiMnCoO₂), Ni-rich layered oxide, organic polydisulfures, FeS, FeS₂, Fe₂(SO₄)₃, iron and lithium phosphates and iron and lithium phosphosilicates having an olivine structure, their analogues wherein iron is at least in part substituted by manganese, and mixtures thereof.

In some instances, the positive electrode active material is LiFePO₄.

In some instances, the amount of the positive electrode active material may range from between about 40 and about 85 wt. %, or may range from between about 65 and about 85 wt. % with regards to the total weight of said positive electrode (not comprising the weight of the optional current collector).

According to a further embodiment of the present technology, the composite material of the positive electrode may further comprise at least one hybrid solid polymer electrolyte as defined herein. In such instances, the amount of said hybrid solid polymer electrolyte may range from between about 15 and about 60 wt. %, or from between about 15 and about 35 wt. % with regards to the total weight of said positive electrode (not including the weight of the optional current collector).

In some embodiments, the current collector of the positive electrode is a sheet of aluminum, which may or may not be coated by a carbon-based layer.

The binding polymer optionally present in the composite material of the positive electrode may be chosen from polyvinylidene fluoride (PVdF) polyethyleneoxide, and electronically conducting cationic polymer such as poly aniline (PANI) or polyethyleneimide (PEI), and mixtures thereof.

The agent generating an electronic conductivity may be chosen from carbon black, SP carbon, acetylene black, carbon fibres and nanofibres, carbon nanotubes, graphene, graphite, metal 30 particles and fibres and a mixture thereof.

The agent generating an electronic conductivity may represent from between about 0.1% and about 10% by weight approximately, or from between about 0.1% and about 2% by weight approximately, relative to the total weight of the positive electrode.

In some embodiments, the operating temperature of the battery of the present technology is less than about 80° C., or is between about 20 and about 40° C. Within this temperature interval, the battery exhibits an ionic conductivity of at least about 2.10⁻⁴ S/cm.

All references cited in this specification, and their references, are incorporated by reference herein in their entirety where appropriate for teachings of additional or alternative details, features, and/or technical background.

While the disclosure has been particularly shown and described with reference to particular embodiments, it will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A hybrid solid polymer electrolyte comprising:
at least one lithium salt in a molar percentage M1; and
at least one ionically conductive polymer in a molar percentage M2;
the at least one lithium salt and the at least one ionically conductive polymer forming a polymer-in-salt-electrolyte;
wherein the molar percentage M1 is at least about 50 mol. % with regards to a total molar percentage M1+M2, and
wherein the polymer-in-salt-electrolyte comprises particles of an ionically conductive inorganic material.

2. The hybrid solid polymer electrolyte according to claim 1, wherein the at least one lithium salt is selected from: lithium fluorate (LiFO₃), lithium bis(trifluoromethanesulfonyl)imide (LiTFSI), lithium hexafluorophosphate (LiPF₆), lithium fluoroborate (LiBF₄), lithium metaborate (LiBO₂), lithium perchlorate (LiClO₄), lithium nitrate (LiNO₃), lithium bis(fluorosulfonyl)imide (LiFSI), lithium iodide (LiI), lithium tetrachloroaluminate (LiAlCl₄), lithium difluoro(oxalate)borate (LiBF₂C₂O₄), and lithium acetate (LiOAc) and mixtures thereof.

3.-4. (canceled)

5. The hybrid solid polymer electrolyte according to claim 1, wherein glyme is combined with the lithium salt.

6. The hybrid solid polymer electrolyte according to claim 1, wherein the at least one lithium salt is combined with at least one ionic liquid.

7. The hybrid solid polymer electrolyte according to claim 6, wherein the at least one ionic liquid is nitrogen based.

8.-9. (canceled)

10. The hybrid solid polymer electrolyte according to claim 6, wherein the at least one ionic liquid is phosphonium based.

11. (canceled)

12. The hybrid solid polymer electrolyte according to claim 6, wherein the at least one ionic liquid is a poly(ionic liquid).

13. (canceled)

14. The hybrid solid polymer electrolyte according to claim 1, wherein the molar amount M1 is at least about 50 mol. % with regards to the total molar amount M1+M2.

15.-19. (canceled)

20. The hybrid solid polymer electrolyte according to claim 1, wherein the at least one ionically conductive polymer is selected from: polyacrylonitriles (PANs), polyethylene carbonates (PECs), polyacrylamides (PAMs), polyethylene glycols (PEGs), polyethylene oxides (PEOs), polyhydroxyethylmethacrylates (P(HEMAs)), polyphosphonates (PPhs), polysiloxanes, polyamides (PAs), polydilactones, polydiesters, polyphasphazenes (PPHOSs), and polyurethane (PUs) and mixtures thereof.

21. (canceled)

22. The hybrid solid polymer electrolyte according to claim 1, wherein the ionically conductive inorganic material is a lithium conductive inorganic material selected from: TiO₂, Li₂O, Al₂O₃, SiO₂, P₂O₅, GeO₂, a lithium perovskite material, Li₃N, Li-β-alumina, Lithium Super-ionic Conductors (LISICON), Lithium Aluminium Titanium Phosphate materials (LATP), Li_{2.88}PO_{3.86}N_{0.14} (UPON), Li₉AlSiO₂, Li₁₀GeP₂S₁₂, lithium garnet materials, doped lithium garnet materials, and lithium garnet composite materials.

23.-28. (canceled)

29. The hybrid solid polymer electrolyte according to claim 1, wherein the particles of the ionically conductive inorganic material have a particle size distribution D99<2 micrometers and a particle size distribution D50<0.1 micrometer.

30.-31. (canceled)

32. The hybrid solid polymer electrolyte according to claim 1, wherein the at least one ionically conductive inorganic material represents from between about 30 and about 80% of the total volume of the hybrid solid polymer electrolyte.

33. (canceled)

34. The hybrid solid polymer electrolyte according to claim 1, wherein the polymer-in-salt electrolyte comprises the at least one lithium salt and the at least one ionically conductive polymer, wherein the at least one lithium salt and the at least one ionically conductive polymer represents from between about 20 and about 70% of the total volume of the hybrid solid polymer electrolyte.

35. The hybrid solid polymer electrolyte according to claim 1, wherein the hybrid solid polymer electrolyte further comprises at least one additional polymer.

36.-38. (canceled)

39. The hybrid solid polymer electrolyte according to claim 1, further comprising at least one additional non-ionically conductive polymer.

40.-41. (canceled)

42. A method for manufacturing a hybrid solid polymer electrolyte according to claim 1, comprising:
combining a molar amount M2 of at least one ionically conductive polymer with a molar amount M1 of at least one lithium salt to form a polymer-in-salt electrolyte in which M1 of the at least one lithium salt is above 50 mol. % with regards to a total molar percentage M1+M2;
adding particles of an ionically conductive inorganic material to the at least one lithium salt and/or in said polymer-in-salt electrolyte to obtain a polymer-in-salt electrolyte comprising particles of an ionically conductive inorganic material; and
applying the polymer-in-salt electrolyte comprising particles of an ionically conductive inorganic material on an inert substrate or directly on a positive or negative electrode.

43. The method according to claim 42, further comprising forming, on at least one face of the hybrid solid polymer electrolyte, an additional layer of an additional ionically conductive polymer different from the ionically conductive polymer present in the hybrid solid polymer electrolyte, said additional layer further comprising at least one lithium salt.

44. (canceled)

45. An all-solid-state secondary battery, comprising:
at least one positive electrode being supported by a current collector, an
at least one negative electrode, the at least one negative electrode being separated from the at least one positive electrode by the hybrid solid polymer electrolyte as defined in claim 1.

46. The battery according to claim 45, wherein the positive electrode is a composite material comprising at least positive electrode active material, at least one binding polymer, at least one agent generating an electronic conductivity, and at least one hybrid solid polymer electrolyte as defined in claim 1.

47.-48. (canceled)

49. The battery according to claim 46, wherein the hybrid solid polymer electrolyte ranges from about 15 and about 60 wt. % with regards to the total weight of said positive electrode.

50.-51. (canceled)
